(19) United States
(12) Patent Application Publication
(10) Pub. No.: US 2006/0142512 A1
(43) Pub. Date: Jun. 29, 2006

(54) Free-radical frontal polymerization with microencapsulated monomers and initiators

(76) Inventors: John A. Pojman, Baton Rouge, LA (US); Brian H. McFarland, Clarksville, AR (US); Zachary Kemp, Mendenhall, MS (US); Sam Popwell, Hattiesburg, MS (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(21) Appl. No.: 11/221,356

(22) Filed: Sep. 7, 2005

Related U.S. Application Data
(60) Provisional application No. 60/607,628, filed on Sep. 7, 2004.

(51) Int. Cl. C08F 4/04

(52) U.S. Cl. 526/219.6; 526/227; 526/318.43

(57) ABSTRACT

A polymerization composition is formed by mixing a monomer polymerizable by frontal polymerization and an encapsulated, free-radical initiator which can be released by the application of heat. In a second embodiment, the monomer is also encapsulated.

This application claims the benefit of provisional application Ser. No. 60/607,628 filed Sep. 7, 2004.

The U.S. Government has a paid-up license in this invention and the right in limited circumstances to require the patent owner to license others on reasonable terms as provided by the terms of contract number NAG8-1466 awarded by NASA.

### BACKGROUND OF THE INVENTION

Polymerizable curing systems are used in a number of applications, including adhesive formulations, polymer repair, and reinforcement of construction elements. Such systems are often premixed and the curing process is initiated by heating the sample. One problem with these premixed systems is that they can suffer from a short pot life, in which the systems over time will react prematurely, rendering them useless for their desired purpose. This invention addresses the issue of pot life by utilizing microencapsulated monomers and free-radical initiators in systems curable by frontal polymerization. Curing by frontal polymerization is advantageous over bulk curing because of the rapid and uniform conversion found in polymer systems. Frontal polymerization entails the conversion of a monomer into a polymer via a localized exothermic reaction zone that propagates through the coupling of thermal diffusion and Arrhenius reaction kinetics.

### SUMMARY OF THE INVENTION

The present invention is directed to processes that use frontal polymerization in a polymerizable curing system. In a preferred embodiment, the initiator is microencapsulated to increase the pot life of the system. Upon application of heat to a surface of the polymerization mixture, the initiator in the microcapsules is released and a polymerization front is created. The heat from the front causes the release of additional initiator as the front moves through the system. In a second embodiment, the monomer is also encapsulated.

### BRIEF DESCRIPTION OF THE DRAWINGS

FIG. 1 is a graph of front velocity of the frontal polymerization of 1,6-hexanediol diacrylate as a function of the amount of cumene hydroperoxide initiator (both encapsulated and unencapsulated) and the ratio of the velocities for a first embodiment of the invention.

FIG. 2 is a graph of front velocity of the frontal polymerization of 1,6-hexanediol diacrylate vs. cobalt naphthenate concentration for the first embodiment.

FIG. 3 is a graph of front velocity of the frontal polymerization of 1,6-hexanediol diacrylate as a function of green density for a second embodiment of the invention.

FIG. 4 is a graph of front velocity of the frontal polymerization of 1,6-hexanediol diacrylate as a function of initiator concentration for the second embodiment.

### DETAILED DESCRIPTION

In a first embodiment, this invention entails the use of a frontal polymerization system in which a free-radical initiator is microencapsulated. The encapsulation of the initiator ensures that the initiator will not come into contact with the rest of the system and prematurely react. This results in a greater pot life for the curing system.

The encapsulation of the initiator may be accomplished by any suitable method. For example, it can be accomplished by the interfacial polymerization of a multifunctional amine (functionality 2 or greater) with a multifunctional isocyanate (functionality 2 or greater) or a multifunctional acid chloride (functionality 2 or greater). This results in the formation of a polyurea (if an isocyanate is used) or a polyamide shell (if an acid chloride is used). The encapsulation of the initiator may also be accomplished by complex coacevation between a cationic polymer (such as gelatin) and an anionic polymer (such as gum arabic or sodium polyphosphate).

The core material is a thermal free-radical initiator, such as a diacyl peroxide, a hydroperoxide, a peroxyketal, a peroxyester, a peroxycarbonate, or 2,2′-azobisisobutyronitrile. In the case of the hydroperoxides and benzyl peroxide, an accelerator such as a metal ion or an N,N-dialkylaniline may be used in the system to increase the reaction rate. Examples of suitable metal ion accelerators include cobalt naphthenate and any organic-soluble transition metal salt.

The curing system is frontally polymerized by applying a localized heat source to the system. The heat causes the core to release by stressing the shell and/or causing an internal buildup in pressure due to core decomposition or vaporization. Once the core initiator is released, the heat source causes it to decompose into radicals and start a localized polymerization. The energy released from the exothermic polymerization diffuses into unreacted monomer, causing more capsules to burst, thus continuing the process. The polymerization may be accelerated in certain cases by using a redox accelerator with the system.

This process may be applied to systems containing thermosets such as 1,6-hexanediol diacrylate (HDDA) or other multifunctional acrylates, or to thermoplastics such as hexyl acrylate, butyl acrylate or benzyl acrylate.

In a second embodiment, the monomer is also encapsulated. Instead of a front propagating through a solution of monomer and initiator, the front propagates through a mixture of powders. If the capsules are tightly packed into the reaction vessel, many of them can be ruptured. The polymerization front is initiated by the application of a localized heat source. The high temperature of the front causes any remaining capsules to burst as the front moves through the mixture.

Until the powders are packed into the reaction vessel or area to be repaired, the system has a very long pot life.

The invention is illustrated by the following examples of various aspects of the present invention.

### EXAMPLE 1

1,6 hexanediol diacrylate (99%, technical grade) (HDDA) was obtained from UCB and used as received. Cumene hydroperoxide (88%) (CHP) and cobalt naphthenate in mineral spirits (8% cobalt) were obtained from Aldrich and used as received.

### Microcapsule Preparation

Microcapsules loaded with a cumene hydroperoxide core were prepared using an interfacial polymerization method. The shell materials consisted of triethylenetetramine (TETA, 60%, technical grade) obtained from Aldrich and MONDUR MRS (a polymeric isocyanate based on 4,4′-diphenylmethane diisocyanate) obtained from Bayer Corporation and were used as received. Polyvinyl alcohol (87-89% hydrolyzed) (PVA) was obtained from Aldrich and used as received.

A solution of the core material was made by dissolving 80 mL of CHP in 10 mL of MONDUR MRS. The core solution was then emulsified in 250 mL of a 1.2% PVA solution with a stirring motor equipped with a 3-bladed propeller. The emulsion contained dispersed-core droplets with a size ranging from 100-275 microns, which was achieved by mixing at 230 rpm for 2 minutes. Once the desired droplet size range was achieved, a solution of 6-13 mL TETA in 12 mL deionized water was added, and the mixture was heated to 50° C. in a water bath. The mixture was allowed to react for 4 hours at 50° C. with continuous mixing at 230 rpm. After 4 hours, the microcapsules were recovered by vacuum filtration and dried overnight with the aid of fumed silica gel (CAB-O-SIL, Cabot Corp.). The dried microcapsules were roughly spherical and had a size ranging from 150-300 microns. The microcapsules were composed of approximately 80% CHP by weight and were washed with heptane prior to use in order to remove any unencapsulated CHP from the outside of the shells.

### Polymerization Tests

The frontal polymerization experiments were performed in glass test tubes, 16×125 mm, on which a plastic cap could be securely screwed. Polymerization was initiated by heating the top of the tube with a soldering iron. Fronts were performed using HDDA systems containing unencapsulated CHP and in systems containing encapsulated CHP. The front velocity was measured over a range of initiator concentrations; the CHP concentrations in the microcapsule systems were calculated using the approximate core weight percentage of the capsules and CHP density. In order to prevent the settling of the microcapsules, ultrafine silica gel (4% w/v) was added to the reaction medium. The same concentration of silica was also used in the unencapsulated CHP systems.

The pot life was assessed by preparing tubes with the reactants and leaving them at ambient temperature and determining at what time they spontaneously polymerized. For the microencapsulated system, several tubes were prepared and their front velocities were determined after several days. The tubes contained HDDA, 4% (w/v) silica, and 2% CHP. In one sample set the CHP was encapsulated and in another sample set the CHP was unencapsulated. An addition of 0.04% (v/v) cobalt naphthenate was added to selected tubes from each sample set.

The front position-versus-time data for all systems were linear, which indicates that constant velocity, self-sustaining fronts were achieved. In each of the systems the front was seen to have a slight convex shape due to higher temperature in the center of the front and maintained this shape uniformly throughout the reaction.

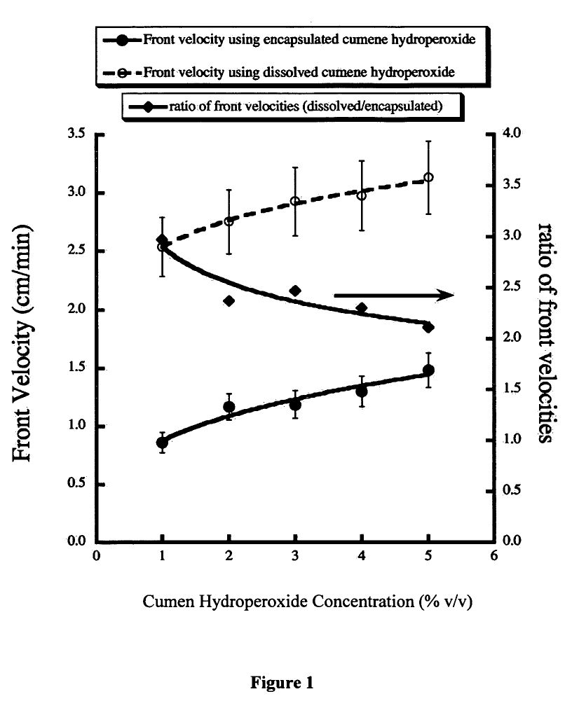

Because the initiator must release from the shell before it can initiate polymerization, it was expected that the front velocity of systems using encapsulated CHP would be slower than in systems in which CHP was dissolved in the monomer. This was tested by running a series of fronts using increasing concentrations of both encapsulated and unencapsulated CHP. FIG. 1 is a graph of the front velocity as a function of the amount of cumene hydroperoxide in both encapsulated and unencapsulated HDDA systems. The ratio of the velocities at the various concentrations is also plotted. The curves are power function fits to the data. FIG. 1 shows that the front velocity of systems using encapsulated CHP is less than half that of systems using dissolved CHP. As has been seen in free-radical chain growth frontal polymerization, the velocity increases monotonically with the initiator concentration.

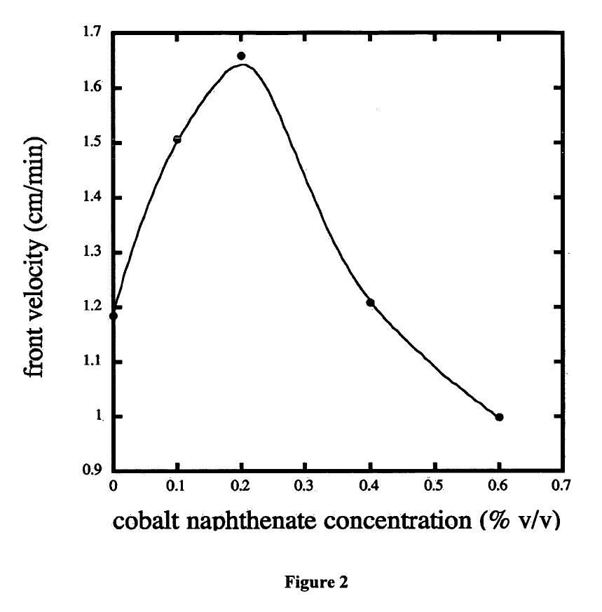

The rate of decomposition of cumene hydroperoxide into radicals can be accelerated by addition of a metal ion, such as Co⁺². The cobalt ion can undergo a redox reaction with the hydroperoxide, which results in the formation of a Co⁺³ ion and a radical. In order to determine if the addition of a cobalt naphthenate accelerator to frontal polymerization systems using encapsulated peroxide would result in an increased front velocity, HDDA systems were created using a constant concentration of encapsulated CHP and increasing concentrations of cobalt naphthenate accelerator, and then frontally polymerized. FIG. 2 shows the velocity dependence on accelerator concentration. The addition of accelerator does increase the front velocity up to a point, but further addition of accelerator causes the front velocity to decrease. This indicates that the ratio of initiator to accelerator must be optimized for each system.

The pot life of HDDA samples was assessed by a combination of visual examination of the systems for spontaneous polymerization and a measurement of front velocity of the samples after a period of storage. Systems were prepared containing HDDA and 2% (v/v) CHP. In one set of samples, CHP was encapsulated and in the other it was unencapsulated. Also, within each set a subset of samples was made in which 0.04% (v/v) cobalt naphthenate accelerator was added. Tubes containing unencapsulated CHP and accelerator spontaneously polymerized after a storage time of 1.5 hours. The tubes containing encapsulated CHP and accelerator were stable for a period of 10 days. The samples that did not contain accelerator did not spontaneously polymerize during the storage period.

In the samples containing accelerator, the front velocity was recorded at the beginning of the storage period and after five days of storage. The samples containing unencapsulated CHP had an initial front velocity of 2.7 cm/min. After five days the velocity was the same. The front of the sample that was stored for five days was difficult to measure due to excessive bubble formation and nonuniformity of the shape of the front. The front quenched halfway down the tube. The samples containing encapsulated CHP had an initial front velocity of 1.3 cm/min. After five days of storage, the velocity had increased to 1.9 cm/min. This indicates there was a slight bit of leakage from the shells. The front remained uniform in shape and maintained a constant velocity after 5 days, and did not show excessive bubble formation.

### EXAMPLE 2

1,6 hexanedioldiacrylate (99%, technical grade) (HDDA) was obtained from UCB and used as received. Cumene hydroperoxide (88%) (CHP) was obtained from Aldrich and used as received.

### Microcapsule Preparation

Microcapsules loaded with a cumene hydroperoxide core were prepared using an interfacial polymerization method. The shell materials consisted of triethylenetetramine (TETA, 60%, technical grade) obtained from Aldrich and MONDUR MRS (a polymeric isocyanate based on 4,4′-diphenylmethane diisocyanate) obtained from Bayer Corporation and were used as received. Polyvinyl alcohol (87-89% hydrolyzed) (PVA) was obtained from Aldrich and used as received.

A solution of the core material was made by dissolving 80 mL of CHP in 10 mL of MONDUR MRS. The core solution was then emulsified in 250 mL of a 1.2% PVA solution with a stir 5 motor equipped with a 3-bladed propeller. The emulsion contained dispersed-core droplets with a size ranging from 100-275 microns, which was achieved by mixing at 230 rpm for 2 minutes. Once the desired droplet size range was achieved, a solution of 6 mL TETA in 12 mL deionized water was added, and the mixture was heated to 50° C. in a water bath. The mixture was allowed to react for 4 hours at 50° C. with continuous mixing at 230 rpm. After 4 hours, the microcapsules were recovered by vacuum filtration and dried overnight with the aid of fumed silica gel (CAB-O-SIL, Cabot Corp.). The dried microcapsules were roughly spherical and had a size ranging from 150-300 microns. The microcapsules were composed of approximately 80% CHP by weight and were washed with hexane prior to use in order to remove any unencapsulated CHP from the outside of the shells. The same procedure was used to prepare monomer-core microcapsules, using HDDA in place of CHP.

The core weight percentages of the capsules were determined using a gravimetric procedure. A 1.0 g sample of microcapsules was weighed. The capsules were then crushed and mixed with approximately 50 mL of methanol in order to extract the core material from the shells. The methanol/capsule mixture was allowed to sit overnight. After extracting the core, the shells were filtered off by vacuum filtration, washed with methanol, allowed to dry, and weighed again. The difference between the microcapsule mass and the empty shell mass was used to calculate the core percentage. The initiator capsules were 80% CHP, and the monomer capsules contained 80% HDDA.

### Polymerization Tests

A mixture containing encapsulated initiator and encapsulated monomer was packed into a 1.5×4.5 cm glass vial with an inner diameter of 1.2 cm. The vial was capped. A heat source (soldering iron) was applied to one end of the vial to initiate polymerization. Once polymerization had begun, the heat source was removed, and the distance traveled by the front and the corresponding time were recorded. The distance was plotted against time to determine the velocity.

A 7.5% (by mass) CHP microcapsule to HDDA microcapsule system was prepared. The volume of the glass vials being used was determined. The glass vials were weighed before and after packing with the microcapsules ot determine the mass of the system within the vial. The mass was divided by the volume of the vial to determine the green density.

The position versus time data for all systems were linear indicating that constant velocity fronts were achieved. The velocity for this system is lower than pure HDDA with a comparable amount of dissolved CHP (3 cm min⁻¹) or with microencapsulated CHP (1.5 cm min⁻¹). Considering that 20% of the volume is comprised of inert capsule walls, then the volumetric heat release is lowered by 20% compared to using neat HDDA. A smaller volumetric heat release results in a lower front temperature and velocity.

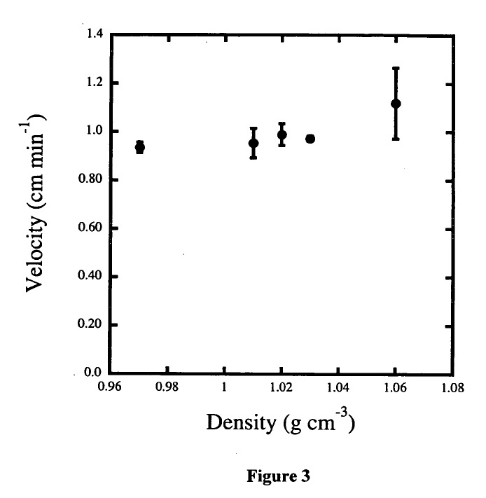

It is quite normal for Self-propagating High Temperature Synthesis (SHS) with inorganic components to exhibit a dependence of the front velocity on the initial or ‘green’ density. The velocity dependence on the green density of mixture was determined (FIG. 3). Below a critical value of 0.97 g cm⁻³, sustained front propagation could not be achieved. Air between the particles would expand and create voids that would interfere with propagation. For the densities studied, most of the capsules were crushed, which may explain the weak dependence on the initial density. Once the CHP capsules and HDDA capsules are brought into intimate contact, further compaction provides little advantage.

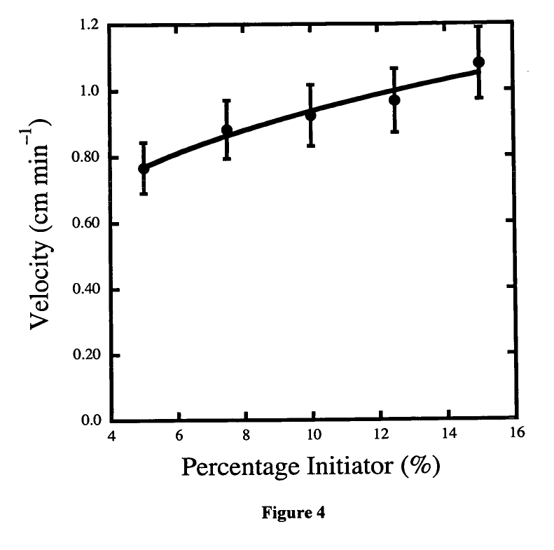

The dependence of the front velocity on the initiator concentration is shown in FIG. 4.

As can be seen from the examples, frontal polymerization of monomer systems can be achieved with microencapsulated initiator or with microencapsulated initiator and monomer. The microencapsulation increases the pot life of the system.

While the invention has been described with respect to the preferred embodiments, it will be appreciated that it can be applied to other monomers and initiators. Accordingly, the invention is defined by the following claims rather than the foregoing description.

What is claimed is:

1. A polymerizable composition comprising:
a monomer polymerizable by frontal polymerization; and
an encapsulated, free-radical initiator which can be released by the application of heat.

2. A polymerizable composition composition as defined in claim 1 wherein the monomer is encapsulated.

3. A polymerizable composition as defined in claim 1 wherein the monomer is a thermal setting or thermal plastic monomer.

4. A polymerizable composition as defined in claim 1 wherein the monomer is selected from the group consisting of 1,6-hexanediol diacrylate, trimethylolpropane triacrylate, hexylacrolate, benzyl acrylate and butyl acrylate.

5. A polymerizable composition as defined in claim 1 wherein the initiator is selected from the group consisting of diacyl peroxides, hydroperoxides, peroxyketals, peroxyesters, peroxycarbonates, and 2,2′-azobisisobutyronitrile.

6. A polymerizable composition as defined in claim 5 wherein the initiator comprises cumene hydroperoxide.

7. A polymerizable composition as defined in claim 1 further comprising an accelerator.

8. A polymerizable composition as defined in claim 7 wherein the accelerator comprises a metal ion or N,N-dialkylaniline.

9. A polymerizable composition as defined in claim 8 wherein the accelerator comprises cobalt naphthenate.

10. A polymerizable composition as defined in claim 1 further comprising a filler.

11. A polymerizable composition as defined in claim 10 wherein the filler comprises silica gel.

12. A polymerizable composition as defined in claim 1 wherein the initiator is encapsulated by a polyurea.

13. A polymerizable composition as defined in claim 1 wherein the initiator is encapsulated by a polyamide.

14. A polymerizable composition comprising:
a monomer polymerizable by frontal polymerization;
an encapsulated, free-radical initiator which can be released by the application of heat; and
an accelerator.

15. A polymerizable composition comprising:
an encapsulated monomer polymerizable by frontal polymerization; and
an encapsulated, free-radical initiator which can be released by the application of heat.

16. A polymerizable composition as defined in claim 15 wherein the monomer is a thermal setting or thermal plastic monomer.

17. A polymerizable composition as defined in claim 15 wherein the monomer is selected from the group consisting of 1,6-hexanedioldiacrylate, trimethylolpropane triacrylate, hexylacrolate, benzyl acrylate and butyl acrylate.

18. A polymerizable composition as defined in claim 15 wherein the initiator is selected from the group consisting of diacyl peroxides, hydroperoxides, peroxyketals, peroxyesters, peroxycarbonates, and 2,2′-azobisisobutyronitrile.

19. A polymerizable composition as defined in claim 18 wherein the initiator comprising cumene hydroperoxide.

20. A polymerizable composition as defined in claim 15 further comprising a filler.

21. A polymerizable composition as defined in claim 20 wherein the filler comprises silica gel.

22. A polymerizable composition as defined in claim 15 wherein the initiator is encapsulated by a polyurea.

23. A polymerizable composition as defined in claim 15 wherein the initiator is encapsulated by a polyamide.

24. A process for forming a polymer by frontal polymerization comprising:
forming a mixture of an encapsulated monomer and a microencapsulated free radical initiator; applying heat to a surface of the mixture to cause microcapsules to rupture and initiate polymerization of the mixture by frontal polymerization.

25. A process for forming a polymer as defined in claim 24 further comprising applying pressure to the encapsulated monomer and initiator to rupture microcapsules prior to initiation of polymerization.
